(19) United States
(12) Patent Application Publication
(10) Pub. No.: US 2005/0029358 A1
(43) Pub. Date: Feb. 10, 2005

(54) Bar code input for camera-equipped wireless devices

(76) Inventor: David Patrick Mankins, Cambridge, MA (US)

Correspondence Address: Edward J. Kelly;ROPES & GRAY LLP, One International Place, Boston, MA, 02110-2624, US

(21) Appl. No.: 10/636,416

(22) Filed: Aug. 7, 2003

(51) Int. Cl. G06F 17/00; G06K 7/10

(52) U.S. Cl. 235/462.46; 235/375

(57) ABSTRACT

A system facilitates the purchase of an item or service using a wireless device (100). The system may capture an image of a bar code (310) associated with a device (300) from which the item or service is being purchased and transmit the image to facilitate payment for the item or service. The system may alternatively process the image to extract information from the image and transmit the extracted information to facilitate payment for the item or service.

### BACKGROUND OF THE INVENTION

1. Field of the Invention

The present invention relates generally to wireless communication and, more particularly, to systems and methods for providing bar code input to camera-equipped wireless devices, such as wireless telephones, to facilitate the performance of transactions.

2. Description of Related Art

Wireless telephones have long been used to provide voice communication. Recently, wireless telephones have begun being used to mediate payments to devices, such as vending machines. When a customer desires to make a purchase from a vending machine, the customer locates a telephone number associated with the vending machine service. The telephone number is typically provided on the vending machine, possibly along with other instructions. For example, the vending machine may provide instructions, such as “To pay using your wireless telephone: (a) call 1-800-123-4567; (b) when prompted, enter the following numbers using your telephone key pad; and (c) follow the instructions provided to you over the telephone.”

After verifying the customer's information and purchase amount, the vending machine service debits the customer's wireless telephone account by the purchase amount. The vending machine service also provides the customer with a number to enter into the keypad of the vending machine to authorize the purchase. Alternatively, the vending machine service may cause a bar code to be displayed on the display of the customer's wireless telephone. In this case, instead of requiring the customer to enter the number into the keypad of the vending machine, the bar code can be scanned using a bar code reader associated with the vending machine. The customer is then provided with the purchased item, thereby completing the transaction.

A problem with this approach is that it is problematic and error-prone. For example, this approach requires the customer to enter a lot of numbers into the keypad of his/her wireless telephone. Misdials would likely be frustrating and impede the usefulness of the vending machine service.

As a result, there is a need for another approach that facilitates transactions performed using wireless devices and is less prone to errors.

### SUMMARY OF THE INVENTION

Systems and methods consistent with the principles of the invention provide bar code input to camera-equipped wireless devices to facilitate purchases made using the wireless devices.

In one aspect consistent with the principles of the invention, a system facilitates the purchase of an item or service using a wireless device. The system may capture an image of a bar code associated with a device from which the item or service is being purchased and transmit the image to facilitate payment for the item or service.

In another aspect, a system for purchasing an item or service using a wireless device is provided. The system may capture an image of a bar code associated with a device from which the item or service is being purchased, process the image to extract information from the image, and transmit the extracted information to facilitate payment for the item or service.

In yet another aspect, a method for performing a transaction using a wireless device is provided. The method may include capturing, using the wireless device, an image of an item associated with a device with which the transaction is being performed and sending the image to a transaction manager associated with the device. The method may also include extracting information from the image and completing the transaction based on the extracted information.

In a further aspect, a method for performing a transaction using a wireless device is provided. The method may include capturing, using the wireless device, an image of an item associated with a device with which the transaction is being performed, processing the image by the wireless device to extract information from the image, and transmitting the extracted information to a transaction manager associated with the device. The method may also include completing the transaction based on the extracted information.

In another aspect, a method for purchasing an item from a vending machine using a wireless telephone that includes an integrated camera is provided. The method may include capturing, by the camera, an image of a bar code associated with one of the item and the vending machine and transmitting the image to a manager associated with the vending machine. The method may also include scanning the image to extract information from the bar code, debiting an account associated with the wireless telephone or an owner of the wireless telephone based on the extracted information, and providing the item from the vending machine.

In yet another aspect, a method for purchasing an item from a vending machine using a wireless telephone that includes an integrated camera is provided. The method may include capturing, by the camera, an image of a bar code associated with one of the item and the vending machine, scanning the image to extract information from the bar code, and transmitting the extracted information to a manager associated with the vending machine. The method may also include debiting an account associated with the wireless telephone or an owner of the wireless telephone based on the extracted information and providing the item from the vending machine.

In a further aspect, a method for purchasing parking time on a parking meter using a wireless telephone that includes an integrated camera is provided. The method may include capturing, by the camera, an image of a bar code associated with the parking meter and transmitting the image to a manager associated with the parking meter. The method may also include scanning the image to extract information from the bar code, debiting an account associated with the wireless telephone or an owner of the wireless telephone based on the extracted information, and providing the parking time on the parking meter.

In another aspect, a method for purchasing parking time on a parking meter using a wireless telephone that includes an integrated camera is provided. The method may include capturing, by the camera, an image of a bar code associated with the parking meter, scanning the image to extract information from the bar code, and transmitting the extracted information to a manager associated with the parking meter. The method may also include debiting an account associated with the wireless telephone or an owner of the wireless telephone based on the extracted information and providing the parking time on the parking meter.

In a further aspect, a transaction manager that includes a receiver and a processor is provided. The receiver is configured to receive image information. The processor is configured to decode the received image information and cause a separate device to provide an item or service in response to the decoded image information.

### BRIEF DESCRIPTION OF THE DRAWINGS

The accompanying drawings, which are incorporated in and constitute a part of this specification, illustrate the invention and, together with the description, explain the invention. In the drawings,

FIGS. 1 and 2 are front and back diagrams, respectively, of an exemplary wireless device according to an implementation consistent with the principles of the invention;

FIG. 3 is an exemplary diagram of an interaction of a wireless device to perform a transaction according to an implementation consistent with the principles of the invention;

FIG. 4 is an exemplary diagram of the display of a wireless device according to an implementation consistent with the present invention; and

FIG. 5 is a flowchart of exemplary processing for performing a transaction using a wireless device according to an implementation consistent with the principles of the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention provide bar code input to camera-equipped wireless devices to facilitate transactions performed using the wireless devices.

### Exemplary Wireless Device

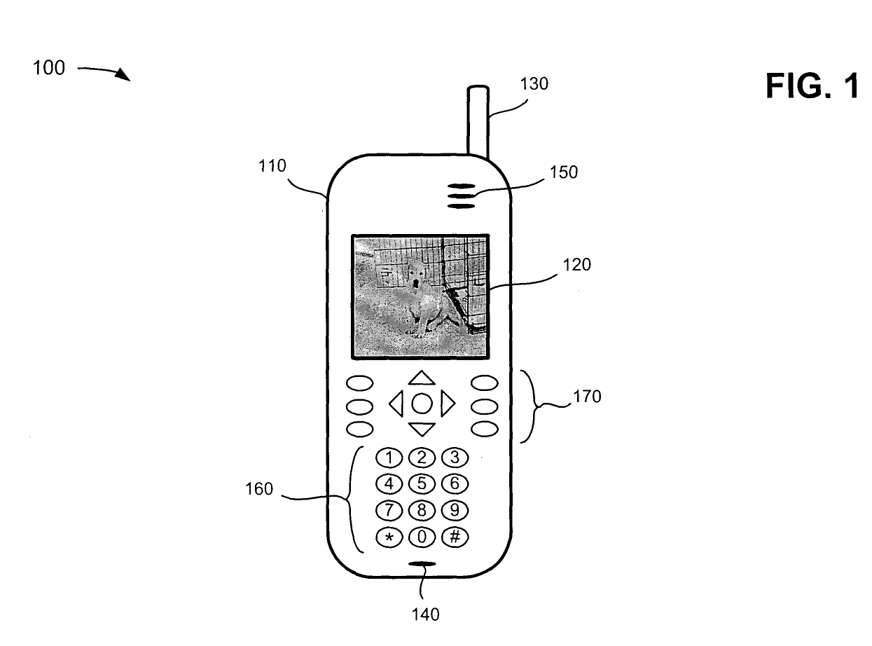

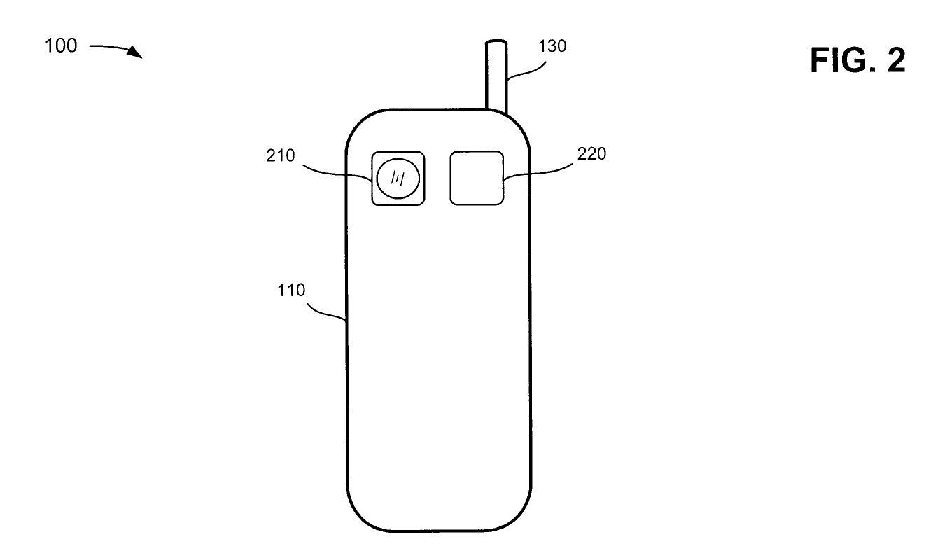

FIGS. 1 and 2 are front and back diagrams, respectively, of an exemplary wireless device 100 according to an implementation consistent with the principles of the invention. As shown in FIGS. 1 and 2, wireless device 100 may take the form of a wireless telephone, such as a cellular, mobile, Code Division Multiple Access (CDMA), or Personal Communication Services (PCS) telephone. Alternatively, wireless device 100 may take another form, such as a portable or handheld computer, personal digital assistant (PDA), pager, or another type of handheld or portable device.

As shown in FIG. 1, wireless device 100 may include housing 110, display 120, antenna 130, microphone 140, speaker 150, keypad 160, and function keys 170. Housing 110 may be constructed of a rigid or semi-rigid material that protects components of wireless device 100. Display 120 may include a conventional display, such as a LCD display, that is capable of displaying images (e.g., photographs), as well as text. Antenna 130 may include a conventional antenna that permits wireless device 100 to communicate with other devices and/or networks.

Microphone 140 may include conventional mechanisms to capture audio information. Speaker 150 may include conventional mechanisms to output audio information. Keypad 160 may include standard keys, such as numeric or alphanumeric keys, that facilitate the inputting of text into wireless device 100. Functional keys 170 may include keys that facilitate interaction with wireless device 100. For example, functional keys 170 may include keys for selecting a phone book, user preferences, games, and/or functions for taking and/or manipulating photographs.

As shown in FIG. 2, wireless device 100 may also include camera 210 and flash 220. Camera 210 may capture still images (e.g., photographs), as well as moving images (e.g., video). Flash 220 may include a standard camera flash that facilitates the capturing of images and video in dark conditions. The manner of integrating a camera with a wireless device is well known in the art and, therefore, will not be described further. For example, wireless telephones with integrated cameras are available from a number of manufacturers, such as Nokia, Sony Ericsson, Sanyo, Sharp, among others. While camera 210 and flash 220 are shown as being located on the back portion of wireless device 100, camera 210 and flash 220 may alternatively be located on the front portion of wireless device 100.

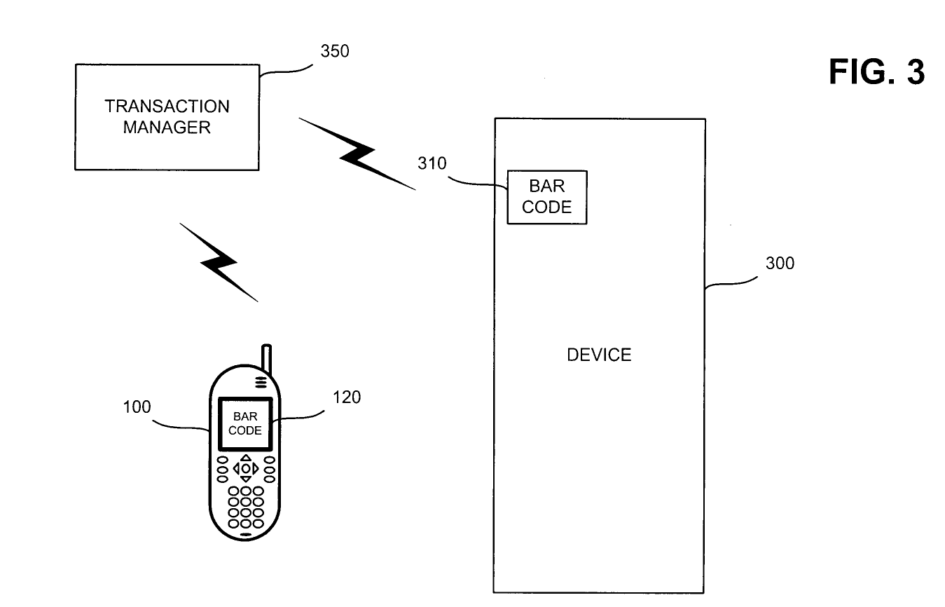

In implementations consistent with the principles of the invention, wireless device 100 may be used to perform a transaction, such as to facilitate the purchasing of an item or service from a device. FIG. 3 is an exemplary diagram of an interaction of wireless device 100 with a device 300 according to an implementation consistent with the principles of the invention. Device 300 may include a vending machine, a parking meter, an interactive terminal, an intelligent door lock, or another type of device with which a user may interact. For example, a user may purchase items, such as food or drinks, from a vending machine. A user may purchase parking time or a ticket that enables the user to park from a parking meter. A user may purchase a ticket for an event, such as a sporting event or a movie, from an interactive terminal. A user may purchase or obtain access to a room that is controlled by a potentially complex security policy via an intelligent door lock.

Device 300 may include one or more bar codes 310. A single bar code is illustrated in FIG. 3, though separate bar codes 310 may be associated with each item or service offered by device 300. Also, other types of codes, other than bar codes, can be used, such as circle codes, random-dot codes, etc.

Bar code 310 may include a conventional bar code that includes a sequence of bars and spaces to represent numbers and other symbols. In an implementation consistent with the principles of the invention, bar code 310 may encode a telephone number, an identifier corresponding to device 300, an identifier corresponding to an item or service to be purchased, a purchase amount, and/or other types of information that may be beneficial to a transaction with device 300.

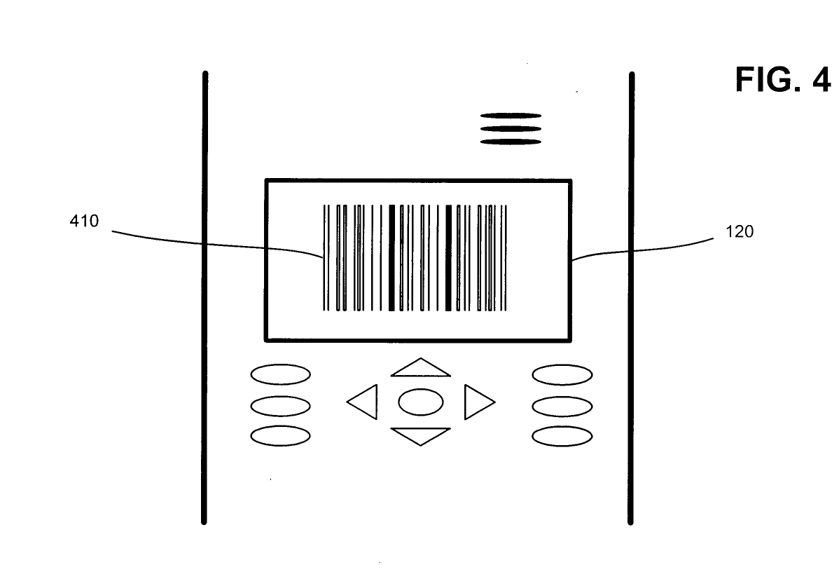

A user of wireless device 100 may use wireless device 100 to photograph bar code 310. For example, the user may use camera 210 (FIG. 2) to capture an image of bar code 310. FIG. 4 illustrates an exemplary diagram of display 120 after capturing an image of bar code 310. As shown, display 120 includes an image 410. The user may use wireless device 100 to transmit image 410 in a conventional manner to facilitate a transaction involving device 300.

Returning to FIG. 3, wireless device 100 and/or device 300 may interact with a transaction manager 350. Transaction manager 350 may include a computer (or a similar device that includes a receiver, transmitter, processor, and memory) that controls transactions involving device 300. For example, transaction manager 350 may be responsible for approving a transaction, debiting an account associated with an owner of wireless device 100 in a purchase amount associated with the transaction, and possibly causing device 300 to provide the purchased item or service.

### Exemplary Processing

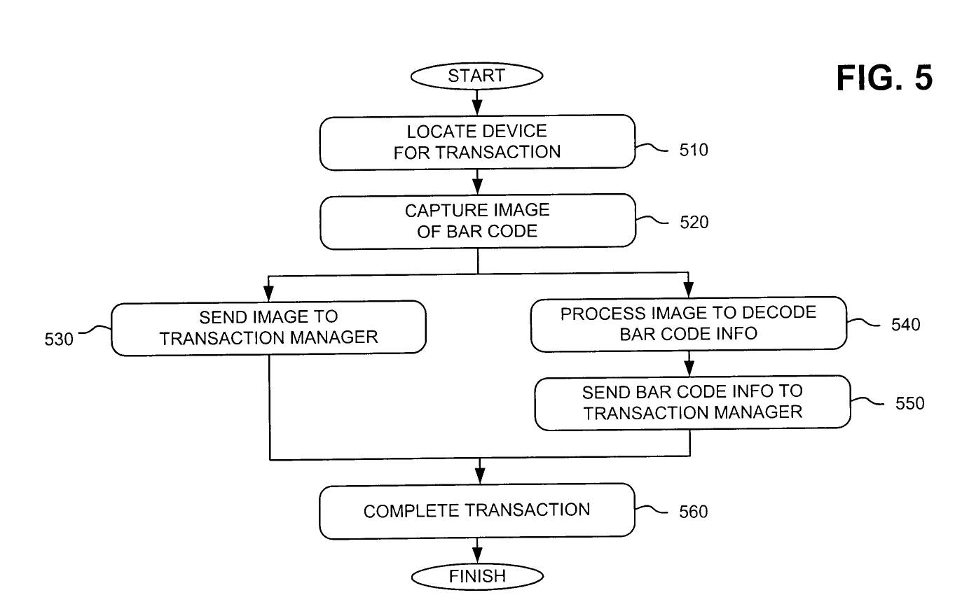

FIG. 5 is a flowchart of exemplary processing for performing a transaction using a wireless device according to an implementation consistent with the principles of the invention. When a user desires to perform a transaction, such as purchasing an item (e.g., a good) or service, the user may locate a device 300 that offers the item or service that the user desires (act 510). As described above, device 300 may include one or more bar codes 310 associated with device 300 or the items/services that device 300 offers. The user may use wireless device 100 to capture an image of a bar code 310 (act 520).

In an implementation consistent with the principles of the invention, the user may cause wireless device 100 to transmit the image of bar code 310 to transaction manager 350 associated with device 300 (act 530). The user may select the appropriate keys of keypad 160 and/or function keys 170 to cause wireless device 100 to communicate with and transmit the image to transaction manager 350 in a conventional manner. For example, the user may enter the telephone number associated with transaction manager 350 and then select a “send image” function on wireless device 100. Wireless device 100 may then send the image to transaction manager 350. Transaction manager 350 may decode the bar code information to identify transaction-specific information, such as identification of device 300, identification of the item or service that the user desires to purchase, a purchase amount, and/or other types of information that may be beneficial to the transaction.

In another implementation consistent with the principles of the invention, the user may cause wireless device 100 to process the image of bar code 310 to decode the bar code information (act 540). In this case, wireless device 100 may include a conventional bar code reader function (i.e., hardware and/or software) to decode bar code 310 to determine the information contained therein. The bar code information may include information, such as the telephone number of the device service, identification of device 300, identification of the item or service that the user desires to purchase, a purchase amount, and/or other types of information that may be beneficial to the transaction. The user may then select the appropriate keys of keypad 160 and/or function keys 170 to cause wireless device 100 to communicate with and transmit the bar code information to transaction manager 350 in a conventional manner (act 550). For example, wireless device 100 may use the telephone number for transaction manager 350 to establish communication with transaction manager 350. Wireless device 100 may then send the bar code information to transaction manager 350.

In either case, transaction manager 350 may process the information to complete the transaction (act 560). For example, transaction manager 350 may determine the user's identity using, for example, the telephone number associated with wireless device 100 that may be detected by transaction manager 350 in a conventional manner. Transaction manager 350 may then verify the user's identity, the item/service to be purchased, and/or the purchase amount. Upon successful verification, transaction manager 350 may debit the user's account. The account may be an account associated with the user's wireless device 100. The account may alternatively be a credit card account linked to the user. In either case, transaction manager 350 may identify the appropriate account that the user desires to use to complete the transaction.

Transaction manager 350 may also provide the user with a number to enter into device 300 (either audibly or via display 120 of wireless device 100), which may cause device 300 to provide the item/service. In an alternative implementation, transaction manager 350 may cause a bar code to be displayed on display 120 of wireless device 100. The user may then scan the bar code using a bar code reader associated with device 300, which may cause device 300 to provide the item/service. In yet another implementation, transaction manager 350 may transmit a signal to device 300 (either directly or via wireless device 100) to cause device 300 to automatically provide the item/service without requiring additional input from the user.

### CONCLUSION

Systems and methods consistent with the present invention provide bar code input to camera-equipped wireless devices to facilitate transactions performed using the wireless devices. Because these systems and methods eliminate the need for a user to enter numbers into a device, such as a vending machine or the user's wireless device, the systems and methods are less prone to errors.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, while a series of acts has been described with regard to FIG. 5, the order of the acts may differ in other implementations consistent with the principles of the invention.

Also, it has been described that a wireless device is used to capture an image of a bar code associated with a device with which a transaction is being performed. In another implementation consistent with the principles of the invention, an image of the actual product desired by the user may be captured. In this case, the transaction manager may include image processing components (i.e., hardware and/or software) to identify the product in the image. In yet another implementation, an image of information in a form other than a bar code (e.g., a series of alphanumeric values) may be captured.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

1. A method for performing a transaction using a wireless device, comprising:
capturing, using the wireless device, an image of an item associated with a device with which the transaction is being performed;
sending the image to a transaction manager associated with the device;
extracting information from the image; and
completing the transaction based on the extracted information.

2. The method of claim 1, wherein the wireless device is a wireless telephone with an integrated camera.

3. The method of claim 1, wherein the wireless device has an integrated camera and is one of a computer, a personal digital assistant, and a pager.

4. The method of claim 1, wherein the device is a vending machine.

5. The method of claim 1, wherein the device is one of a parking meter, an interactive terminal, and an intelligent door lock.

6. The method of claim 1, wherein the wireless device includes a camera and the item includes a bar code; and
wherein the capturing an image includes:
capturing an image of the bar code using the camera.

7. The method of claim 6, wherein the extracting information from the image includes:
scanning the bar code from the image using a bar code reader.

8. The method of claim 1, wherein the transaction includes a purchase of a good or service; and
wherein the completing the transaction includes:
providing the good or service.

9. The method of claim 8, wherein the completing the transaction further includes:
debiting an account associated with the wireless device or an owner of the wireless device in an amount of the purchase.

10. The method of claim 1, wherein the extracting information from the image is performed by the wireless device; and
wherein the sending the image to the transaction manager associated with the device includes:
transmitting the extracted information to the transaction manager associated with the device.

11. A system for purchasing an item or service using a wireless device, comprising:
means for capturing an image of a bar code associated with the item or service being purchased; and
means for transmitting the image to facilitate payment for the item or service.

12. The system of claim 11, wherein the wireless device is a wireless telephone with an integrated camera.

13. The system of claim 11, wherein the wireless device has an integrated camera and is one of a computer, a personal digital assistant, and a pager.

14. The system of claim 11, wherein the item or service is being purchased from a vending machine.

15. The system of claim 11, wherein the item or service is being purchased from one of a parking meter, an interactive terminal, and an intelligent door lock system.

16. The system of claim 11, wherein the means for capturing includes a camera.

17. The system of claim 11, further comprising:
means for extracting information from the image.

18. The system of claim 17, wherein the means for sending the image includes means for transmitting the extracted information to facilitate payment for the item or service.

19. A method for performing a transaction using a wireless device, comprising:
capturing, using the wireless device, an image of an item associated with a device with which the transaction is being performed;
processing the image by the wireless device to extract information from the image;
transmitting the extracted information to a transaction manager associated with the device; and
completing the transaction based on the extracted information.

20. The method of claim 19, wherein the wireless device is a wireless telephone with an integrated camera.

21. The method of claim 19, wherein the wireless device has an integrated camera and is one of a computer, a personal digital assistant, and a pager.

22. The method of claim 19, wherein the device is a vending machine.

23. The method of claim 19, wherein the device is one of a parking meter, an interactive terminal, and an intelligent door lock.

24. The method of claim 19, wherein the wireless device includes a camera and the item includes a bar code; and
wherein the capturing an image includes:
taking an image of the bar code using the camera.

25. The method of claim 24, wherein the processing the image includes:
scanning the bar code from the image using a bar code reader function.

26. The method of claim 19, wherein the transaction includes a purchase of a good or service; and
wherein the completing the transaction includes:
providing the good or service.

27. The method of claim 26, wherein the completing the transaction further includes:
debiting an account associated with the wireless device or a credit card associated with an owner of the wireless device in an amount of the purchase.

28. A system for purchasing an item or service using a wireless device, comprising:
means for capturing an image of a bar code associated with a device from which the item or service is being purchased;
means for processing the image to extract information from the image; and
means for transmitting the extracted information to a transaction manager associated with the device to facilitate payment for the item or service.

29. The system of claim 28, wherein the wireless device is a wireless telephone with an integrated camera.

30. The system of claim 28, wherein the wireless device is one of a computer, a personal digital assistant, and a pager with an integrated camera.

31. The system of claim 28, wherein the device is a vending machine.

32. The system of claim 28, wherein the device is one of a parking meter, an interactive terminal, and an intelligent door lock.

33. The system of claim 28, wherein the means for capturing an image includes a camera.

34. The system of claim 33, wherein the means for processing the image includes means for scanning the bar code from the image using a bar code reader function.

35. A method for purchasing an item from a vending machine using a wireless telephone that includes an integrated camera, comprising:
capturing, by the camera, an image of a bar code associated with one of the item and the vending machine;
transmitting the image to a manager associated with the vending machine;
scanning the image to extract information from the bar code;
debiting an account associated with the wireless telephone or an owner of the wireless telephone based on the extracted information; and
providing the item from the vending machine.

36. A method for purchasing an item from a vending machine using a wireless telephone that includes an integrated camera, comprising:
capturing, by the camera, an image of a bar code associated with one of the item and the vending machine;
scanning the image to extract information from the bar code;
transmitting the extracted information to a manager associated with the vending machine;
debiting an account associated with the wireless telephone or an owner of the wireless telephone based on the extracted information; and
providing the item from the vending machine.

37. A method for purchasing parking time on a parking meter using a wireless telephone that includes an integrated camera, comprising:
capturing, by the camera, an image of a bar code associated with the parking meter;
transmitting the image to a manager associated with the parking meter;
scanning the image to extract information from the bar code;
debiting an account associated with the wireless telephone or an owner of the wireless telephone based on the extracted information; and
providing the parking time on the parking meter.

38. A method for purchasing parking time on a parking meter using a wireless telephone that includes an integrated camera, comprising:
capturing, by the camera, an image of a bar code associated with the parking meter;
scanning the image to extract information from the bar code;
transmitting the extracted information to a manager associated with the parking meter;
debiting an account associated with the wireless telephone or an owner of the wireless telephone based on the extracted information; and
providing the parking time on the parking meter.

39. A transaction manager, comprising:
a receiver configured to receive image information; and
a processor configured to:
decode the received image information as decoded image information, and
cause a separate device to provide an item or service in response to the decoded image information.
